(19) United States
(12) Patent Application Publication
(10) Pub. No.: US 2026/0301352 A1
(43) Pub. Date: Oct. 1, 2026

(54) METHOD, APPARATUS, DEVICE, STORAGE MEDIUM AND PROGRAM PRODUCT FOR REPLY PROVISION

(71) Applicant: Beijing Zitiao Network Technology Co., Ltd., Beijing (CN)

(72) Inventors: Xuan Li, Beijing (CN); Yutong Zhao, Beijing (CN); Jianfeng Xiang, Beijing (CN)

(21) Appl. No.: 19/428,783

(22) Filed: Dec. 22, 2025

(30) Foreign Application Priority Data
Mar. 31, 2025 (CN) 202510400046.0

(51) Int. Cl. G06V 10/10; G06V 10/82; H04N 23/60; H04N 23/80

(52) U.S. Cl. CPC G06V 10/10; G06V 10/82; H04N 23/64; H04N 23/815

(57) ABSTRACT

The disclosure provides a method, an apparatus, a device, a storage medium and a program product for reply provision. The method includes: determining, during a question-answer interaction, a target resolution for a visual data based on at least one of a type of the visual data required for the question-answer interaction, an interaction mode related to the visual data, or a device capability of an acquisition device; acquiring the visual data using the acquisition device based on the target resolution; providing the acquired visual data to a machine learning model for processing; and obtaining a reply for the visual data, the reply being based on a model output of the machine learning model.

### CROSS-REFERENCE

This application claims the priority to Chinese Patent Application No. 202510400046.0, filed on Mar. 31, 2025, and entitled “METHOD, APPARATUS, DEVICE, STORAGE MEDIUM AND PROGRAM PRODUCT FOR REPLY PROVISION”, the entire content of which is incorporated herein by reference.

### TECHNICAL FIELD

Example embodiments of the present disclosure generally relate to the field of computers, and in particular, to a method, an apparatus, an electronic device, a computer-readable storage medium, and a computer program product for reply provision.

### BACKGROUND

With the development of information technology, various terminal devices may provide various services for people in work and life. For example, a service-providing application may be deployed in a terminal device. The terminal device or the application may provide a digital assistant-type function for a user to assist the user in using the terminal device or the application. The user may perform diverse operations through various interactions with the digital assistant.

### SUMMARY

In a first aspect of the present disclosure, a method for reply provision is provided. The method includes: determining, during a question-answer interaction, a target resolution for visual data based on at least one of a type of the visual data required for the question-answer interaction, an interaction mode related to the visual data, or a device capability of an acquisition device; acquiring the visual data using the acquisition device based on the target resolution; providing the acquired visual data to a machine learning model for processing; and obtaining a reply for the visual data, the reply being based on a model output of the machine learning model.

In a second aspect of the present disclosure, an apparatus for reply provision is provided. The apparatus includes: a resolution determination module configured to determine, during a question-answer interaction, a target resolution for a visual data based on at least one of a type of the visual data required for the question-answer interaction, an interaction mode related to the visual data, or a device capability of an acquisition device; a visual data acquisition module configured to acquire the visual data using the acquisition device based on the target resolution; a visual data provision module configured to provide the acquired visual data to a machine learning model for processing; and a reply obtaining module configured to obtain a reply for the visual data, the reply being based on a model output of the machine learning model.

In a third aspect of the present disclosure, an electronic device is provided. The electronic device includes: at least one processor; and at least one memory, the at least one memory being coupled to the at least one processor and storing instructions executable by the at least one processor, the instructions, when executed by the at least one processor, cause the electronic device to perform the method of the first aspect of the present disclosure.

In a fourth aspect of the present disclosure, a computer-readable storage medium is provided. The computer-readable storage medium stores a computer program thereon which, when executed by a processor, causes the processor to perform the method of the first aspect of the present disclosure.

In a fifth aspect of the present disclosure, a computer program product is provided. The computer program product is tangibly stored in a computer storage medium and includes computer-executable instructions which, when executed by a device, cause the device to perform the method of the first aspect.

It should be understood that the content described in this summary section is not intended to identify key or essential features of the embodiments of the present disclosure, nor is it intended to limit the scope of the present disclosure. Other features of the present disclosure will be readily envisaged through the following description.

### BRIEF DESCRIPTION OF THE DRAWINGS

The above and other features, advantages, and aspects of the embodiments of the present disclosure will become more apparent in combination with the drawings and with reference to the following detailed description. In the drawings, the same or similar reference numbers refer to the same or similar elements, where:

FIG. 1 illustrates a schematic diagram of an example environment in which the embodiments of the present disclosure may be implemented;

FIG. 2 illustrates an example interaction interface during a question-answer interaction between a user and a digital assistant;

FIG. 3 illustrates an example of reply provision according to some embodiments of the present disclosure;

FIG. 4 illustrates a flowchart of a method for reply provision according to some embodiments of the present disclosure;

FIG. 5 illustrates an illustrative structural block diagram of an apparatus for reply provision according to some embodiments of the present disclosure; and

FIG. 6 illustrates a block diagram of an electronic device in which one or more embodiments of the present disclosure may be implemented.

### DETAILED DESCRIPTION OF EMBODIMENTS

The embodiments of the present disclosure are described in more detail below with reference to the drawings. Although some embodiments of the present disclosure are shown in the drawings, it should be understood that the present disclosure may be implemented in various forms and should not be construed as limited to the embodiments set forth herein. Instead, these embodiments are provided for a more thorough and complete understanding of the present disclosure. It should be understood that the drawings and the embodiments of the present disclosure are only for illustrative purposes and are not intended to limit the protection scope of the present disclosure.

In the description of the embodiments of the present disclosure, the term “include/comprise” and similar terms should be understood as open-ended inclusions, that is, “include/comprise but not limited to”. The term “based on” should be understood as “at least partially based on”. The term “an embodiment” or “the embodiment” should be understood as “at least one embodiment”. The term “some embodiments” should be understood as “at least some embodiments”. The following may also include other explicit and implicit definitions.

In this specification, unless explicitly stated, “performing a step in response to A” does not mean that the step is performed immediately after “A”, but may include one or more intermediate steps.

It may be understood that the data involved in the technical solution (including but not limited to the data itself, acquisition, use, storage, or deletion of the data) should comply with requirements of corresponding laws, regulations, and related provisions.

It may be understood that before the use of the technical solutions disclosed in the embodiments of the present disclosure, the user should be informed of the type, range of use, use scenarios, etc., of personal information involved in the present disclosure and the authorization of the user should be obtained in an appropriate way in accordance with relevant laws and regulations.

For example, in response to reception of an active request from a user, prompt information is sent to the user to clearly prompt the user that the requested operation will require access to and use of personal information of the user, so that the user may independently choose, according to the prompt information, whether to provide the personal information to software or hardware, such as an electronic device, an application, a server, or a storage medium, that performs the operations of the technical solutions of the present disclosure.

As an optional but non-restrictive implementation, in response to reception of an active request from a user, the prompt information may be sent to the user, for example, in the form of a pop-up window, and the prompt information may be presented in the pop-up window in text. In addition, the pop-up window may also carry a selection control for the user to select “agree” or “disagree” to provide personal information to the electronic device.

It may be understood that the above process of notifying and obtaining the authorization of the user is only illustrative and does not limit the implementation of the present disclosure. Other ways that meet relevant laws and regulations may also be applied to the implementation of the present disclosure.

As used herein, the term “model” may learn the correlation between the corresponding input and output from the training data, so that the corresponding output may be generated for a given input after the training is completed. The generation of the model may be based on machine learning techniques. Deep learning is a machine learning algorithm that uses multiple layers of processing units to process input and provide the corresponding output. A neural network model is an example of a model based on deep learning. In this specification, the “model” may also be referred to as a “machine learning model”, a “learning model”, a “machine learning network” or a “learning network”, which terms are used interchangeably herein.

A “neural network” is a machine learning network based on deep learning. A neural network may process input and provide a corresponding output, and it typically includes an input layer and an output layer, and one or more hidden layers between the input layer and the output layer. Neural networks used in deep learning applications typically include many hidden layers, thereby increasing the depth of the network. The various layers of the neural network are connected in sequence, so that the output of the previous layer is provided as the input of the next layer, where the input layer receives the input of the neural network, and the output of the output layer serves as the final output of the neural network. Each layer of the neural network includes one or more nodes (also called processing nodes or neurons), and each node processes the input from the previous layer.

Generally, machine learning may roughly include three stages, that is, a training stage, a testing stage, and an application stage (also called an inference stage). In the training stage, a given model may be trained using a large amount of training data, and the parameter values may be updated through continuous iteration until the model may obtain consistent inference that meets the expected target from the training data. Through training, the model may be considered to be able to learn the correlation from input to output (also called mapping from input to output) from the training data. The parameter values of the trained model are determined. In the testing stage, a test input is applied to the trained model to test whether the model may provide a correct output, thereby determining the performance of the model. The testing stage may sometimes be merged with the training stage. In the application or inference stage, the trained model may be used to process the actual model input based on the parameter values obtained from the training, and determine the corresponding model output.

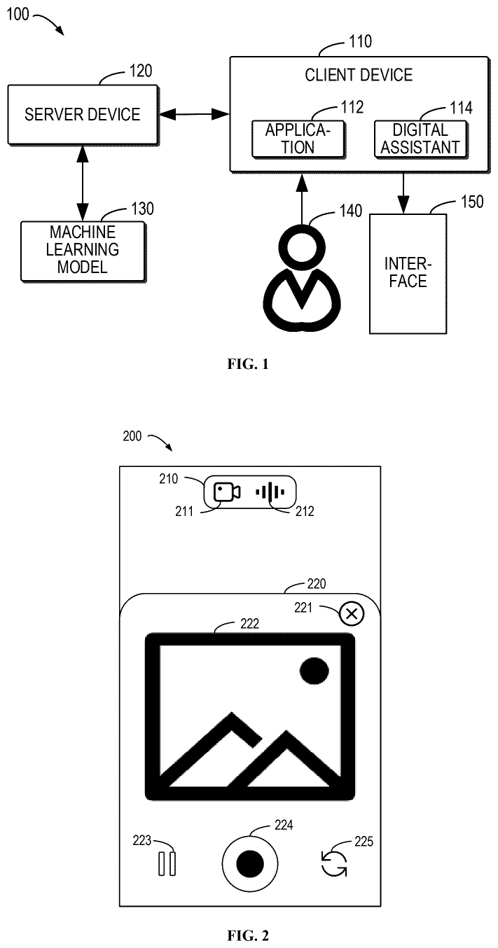

FIG. 1 illustrates a schematic diagram of an example environment 100 in which the embodiments of the present disclosure may be implemented. In this example environment 100, an application 112 and a digital assistant 114 are installed in a client device 110. A user 140 may interact with the application 112 via the client device 110 and/or an attachment device of the client device 110. In some implementations, the application 112 may be authorized to acquire voice via an audio acquisition device (e.g., a microphone) of the client device 110, and to acquire visual data (e.g., images or videos, etc.) via an acquisition device (e.g., a camera) of the client device 110, and so on.

In some embodiments, the application 112 and the digital assistant 114 may be downloaded and installed in the client device 110. In some embodiments, the application 112 and the digital assistant 114 may also be accessed in other ways, for example, through a web page, etc.

In the embodiments of the present disclosure, the application 112 may be any appropriate application with a reply function, which may include but not limited to one or more of the following: a chat application component (also referred to as an instant messaging application component), a browser application component, a planning application component, a document application component, an audio and video conference application component, an email application component, a task application component, a calendar application component, an objective and key result (OKR) application component, etc. It may be understood that although a single application is shown in FIG. 1, multiple applications may actually be installed in the client device 110. In some embodiments, the application 112 may include a multi-functional collaboration platform, for example, an office collaboration platform (also referred to as an office suite) may provide integration of multiple types of business components to facilitate office, communication and other activities of people. In the multi-functional collaboration platform, people may start different business components as needed to complete corresponding information processing, sharing, communication, etc.

In some embodiments, the digital assistant 114 may be provided by a separate application or integrated in an application 112 that may provide a content entity. The application business component for providing the client interface of the digital assistant may correspond to a single-function application business component or a multi-functional collaboration platform, such as an office suite or other collaboration platforms that may integrate multiple components. It may be understood that, similar to the application, although a single digital assistant is shown in FIG. 1, there may actually be multiple digital assistants.

In some embodiments, the digital assistant 114 supports the use of plugins. Each plugin may provide one or more functions of the application. Such plugins include, but are not limited to, one or more of the following: a search plugin, a contact plugin, a message plugin, a document plugin, a table plugin, an email plugin, a calendar plugin, a schedule plugin, a task plugin, etc.

The digital assistant 114 is an intelligent assistant of the user, and has intelligent conversation and information processing capabilities. In the embodiments of the present disclosure, the digital assistant 114 is configured to interact with the user 140 to assist the user 140 in using the client device 110 or the application 112. In some embodiments, multiple interaction modes between the user 140 and the digital assistant 114 may be provided, and flexible switching between the multiple interaction modes is possible. In the case where a certain interaction mode is triggered, a corresponding interaction region is presented to facilitate the interaction between the user 140 and the digital assistant 114. The interaction ways between the user 140 and the digital assistant 114 in different interaction modes are different, which may flexibly adapt to the interaction requirements in different application scenarios.

In the environment 100, in response to the application 112 and/or the digital assistant 114 being started, the client device 110 may present an interface 150 of the application 112 and/or the digital assistant 114. The interface 150 may include, for example, an interaction interface of the application 112 and the digital assistant 114. In some embodiments, an interaction window between the user 140 and the digital assistant 114 may be presented in the interface 150. In the interaction window, the user 140 may talk with the digital assistant 114 by inputting natural language, pictures, audio files, video files, web page files, etc., to indicate the digital assistant to assist in completing various tasks.

The interaction window between the digital assistant 114 and the user 140 may include a chat window, such as a chat window in an instant messaging application or an instant messaging module of a specific application. In the chat window, the interaction between the digital assistant 114 and the user 140 may be presented in the form of a chat message. Alternatively or additionally, the interaction window between the digital assistant 114 and the user 140 may also include other types of windows, such as a window in a floating window mode, in which the user 140 may trigger the digital assistant 114 to perform corresponding operations by inputting instructions, selecting quick instructions, etc.

In some embodiments, the digital assistant 114 may support an interaction mode of a chat window, which may also be referred to as a chat mode. In this interaction mode, a chat window between the user 140 and the digital assistant 114 is presented, and the user 140 and the digital assistant 114 interact through the chat message in the chat window. In the chat mode, the digital assistant 114 may perform tasks according to the chat message in the chat window. In the interaction window, the user 140 inputs an interaction message, and the digital assistant 114 provides a reply message in response to the user input. By selecting the digital assistant 114, the chat window with the digital assistant 114 may be opened. The chat window may include an interface element for information exchange, such as an input box, a message list, a message bubble, etc.

In some embodiments, a communication connection is established between the client device 110 and the server device 120. The communication connection may be established by a wired or wireless way. The communication connection may include, but is not limited to, a Bluetooth connection, a mobile network connection, a Universal Serial Bus (USB) connection, a Wireless Fidelity (WiFi) connection, etc., and the embodiments of the present disclosure are not limited in this regard. In the embodiments of the present disclosure, the client device 110 and the server device 120 may implement signaling interaction through the communication connection therebetween to implement the supply of the services of the application 112 and/or the digital assistant 114.

As shown in FIG. 1, the server device 120 may invoke a machine learning model 130 to support the reply function of the application 112 based on the output of the machine learning model 130. The machine learning model 130 may be based on any appropriate model structure, including but not limited to a Transformer model, a convolutional neural network (CNN), a recurrent neural network (RNN), a deep neural network (DNN), etc. In some embodiments, the machine learning model 130 may be based on a language model (LM). The language model may have question-answer capabilities by learning from a large amount of corpus. The machine learning model 130 may also be based on other appropriate models.

The machine learning model 130 may be deployed on the server device 120 or on other devices. The machine learning model 130 may include one or more machine learning models. It should be noted that if the machine learning model 130 includes multiple machine learning models, these multiple machine learning models may have different structures, uses, and functions, which are not limited in the present disclosure. It should be noted that a machine learning model (not shown) may also be deployed locally on the client device 110, and the client device 110 may also directly invoke the local machine learning model to support the reply function of the application 112 based on the output of the local machine learning model.

The client device 110 may be any type of mobile terminal, fixed terminal, or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/video camera, a positioning device, a television receiver, a radio broadcast receiver, an e-book device, a game device, or any combination of the above, including the accessories and peripherals of these devices or any combination thereof. In some embodiments, the client device 110 may also support any type of interface for the user (such as a “wearable” circuit, etc.).

The server device 120 may be an independent physical server, a server cluster or distributed system composed of multiple physical servers, or a cloud server that provides basic cloud computing services such as cloud services, cloud databases, cloud computing, cloud functions, cloud storage, network services, cloud communications, middleware services, domain name services, security services, content delivery networks, and big data and artificial intelligence platforms. The server device 120 may include, for example, a computing system/server, such as a mainframe, an edge computing node, a computing device in a cloud environment, etc.

It should be understood that the structure and function of various elements in the environment 100 are described only for the purpose of illustration, and do not imply any limitation on the scope of the present disclosure.

As mentioned above, the user may complete diverse operations by various question-answer interactions with the digital assistant. In the process of the question-answer interaction, the client device corresponding to the user provides visual data to assist the digital assistant. The digital assistant may use the machine learning model to determine the reply for the visual data. Generally, the accuracy of the reply may be affected by the quality of the visual data, especially the resolution of the visual data. For example, insufficient resolution of an image or video may lead to poor recognition effect of the model on the image or video. On the other hand, too high resolution may lead to slow inference speed of the machine learning model, which may affect the efficiency of the reply.

Traditionally, visual data is usually acquired and uploaded at a fixed resolution for processing by the machine learning model. This may result in the inability to take into account the quality of the visual data, the accuracy of the reply and the model inference speed. At low resolution, important visual details may be lost, while at high resolution, the processing speed may be significantly reduced, affecting the user experience. Therefore, how to dynamically adjust the image resolution in different scenarios to take into account the image quality and processing efficiency has become a problem to be solved.

In view of this, according to the embodiments of the present disclosure, an improved solution for reply provision is provided. According to the solution of the embodiments of the present disclosure, during the question-answer interaction, the target resolution for the visual data is dynamically determined based on at least one of the type of the visual data required for the question-answer interaction, the interaction mode related to the visual data, or the device capability of the acquisition device. The visual data is acquired using the acquisition device based on the target resolution. The acquired visual data is provided to the machine learning model for processing. The reply for the visual data is obtained.

In this way, an appropriate resolution strategy for the visual data may be determined based on one or more of the type of the visual data required for the question-answer interaction, the interaction mode related to the visual data, or the device capability of the acquisition device. This may flexibly determine the resolution of the visual data provided to the machine learning model based on the actual scenario, improve the effect of visual recognition of the model, and thus contribute to improving the quality of the reply and the efficiency of the reply.

Some example embodiments of the present disclosure are described below with continued reference to the drawings. The reply provision method involved in the present disclosure may be implemented on the client device 110. It should be noted that the operations performed by the client device 110 may specifically be performed by a related application and/or a digital assistant installed in the client device 110. Some operations described with reference to the client device 110 may require the assistance of the server device 120 to complete.

A digital assistant (e.g., the digital assistant 114) may be running in the client device 110. The client device 110 may provide an interaction interface between the user and the digital assistant during the question-answer interaction between the user (e.g., the user 140) and the digital assistant. The process of the question-answer interaction may involve the acquisition of visual data.

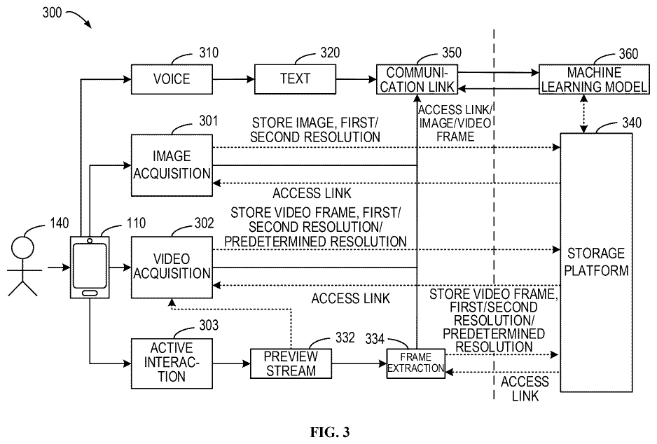

FIG. 2 illustrates an example interaction interface 200 in the process of question-answer interaction between a user and a digital assistant. The example interaction interface 200 may include a region 210, and the region 210 includes a visual acquisition control 211 and a voice acquisition control 212. The client device 110 may start a voice acquisition state and acquire the voice in the voice acquisition state in response to reception of a trigger on the voice acquisition control 212. The client device 110 may also determine to acquire visual data in response to reception of a trigger on the visual acquisition control 211, and then present a framing interface 220. The visual data may include videos and/or images.

The client device 110 may open an acquisition device (e.g., a camera) in response to the framing interface 220 being presented, and present, in a region 222, visual data that may be acquired by the acquisition device. In some embodiments, in the case where multiple acquisition devices are included, the framing interface 220 may further include a lens switching control 225. The client device 110 may switch the acquisition device currently being applied in response to reception of a trigger on the lens switching control 225. As an example, if the client device 110 may include a front-facing camera and a rear-facing camera, and the rear-facing camera is currently being applied, the content that may be acquired by the rear-facing camera may be presented in the region 222. The client device 110 may switch to the front-facing camera in response to reception of the trigger on the lens switching control 225, and the content that may be acquired by the front-facing camera may be presented in the region 222. Certainly, in addition to the front-facing camera and the rear-facing camera, the client device 110 may also be equipped with other acquisition device capabilities, depending on the specific device configuration.

In the process of question-answer, the client device 110 may acquire visual data, such as images or videos, via the framing interface 220 in response to the trigger for the acquisition of the visual data. The acquisition trigger modes of the visual data include automatic trigger and user trigger. The automatic trigger may be that in the process of interaction between the user and the application or the digital assistant, the client device 110 automatically determines to trigger the acquisition of visual data according to the interaction context, and automatically acquires the visual data currently presented in the region 222 for object recognition via the framing interface with the confirmation of the user. The interaction context may include the device information of the client device 110, the predetermined configuration information of the interaction, the historical data of the interaction, etc. The user trigger refers to that in the process of interaction, it is necessary to receive the trigger from the user on a shooting control (e.g., a shooting control 224), and then to acquire the visual data in response to the trigger. That is, the user trigger requires an explicit indication from the user to indicate the acquisition of visual data, while the automatic trigger does not.

It may be understood that if the visual data is a video, the client device 110 may acquire at least one video frame, and if the visual data is an image, the client device 110 may acquire the image. In some embodiments, in order to ensure that the acquired visual data includes as much content as possible, the visual data acquired by the client device 110 may be a video. That is, the client device 110 may acquire at least one video frame on its own in response to the need to acquire visual data (e.g., reception of the acquisition trigger for the visual data). In the following, unless otherwise specified, the case where the client device 110 acquires at least one video frame is taken as an example for description.

In some embodiments, in the case where the video frame is acquired via the automatic trigger mode, the client device 110 may further present, in the framing interface 220, prompt information indicating that the video frame is currently being acquired via the automatic trigger mode. The prompt information may be any appropriate prompt information such as a prompt text, a prompt symbol, a prompt icon, etc. As an example only, it may be the prompt text “Sharing field of view . . . ” shown in Example 200A. In some embodiments, in the case where the video frame is acquired via the automatic trigger mode, the client device 110 may further present a pause control 223. The client device 110 may pause acquiring the video frame via the automatic trigger mode in response to reception of a trigger on the pause control 223. Certainly, in some embodiments, the client device 110 may also determine to perform object recognition on the image corresponding to the pause moment (i.e., the image or video frame presented in the region 222 at the pause moment) in response to reception of the trigger on the pause control 223.

The framing interface 220 may further include the shooting control 224. In some embodiments, the client device 110 may determine that the acquisition trigger mode of the visual data is the user trigger mode in response to reception of the trigger from the user on the shooting control 224, and then acquire video and/or images via the camera. In this case, the client device 110 may further stop acquiring the video and/or image in response to the stop of the trigger on the shooting control 224 or in response to reception of the trigger on the shooting control 224 again.

For example, the client device 110 may determine that the trigger from the user on the shooting control is received in response to reception of a long press operation on the shooting control 224, and start acquiring video via the camera. The client device 110 may then stop acquiring video via the camera in response to the end of the long press operation on the shooting control 224. For another example, the client device 110 may determine that the trigger from the user on the shooting control is received in response to reception of a click operation on the shooting control 224, and start acquiring video via the camera. The client device 110 may then stop acquiring video via the camera in response to reception of the click operation on the shooting control 224 again. It may be understood that if an image is to be acquired, the client device 110 may acquire the image via the camera in response to reception of another trigger on the shooting control 224 (e.g., a click operation) or a trigger on another shooting control corresponding to the image acquisition.

In some embodiments, the framing interface 220 may further include a cancel control 221. In response to reception of a trigger on the cancel control 221, the client device 110 may no longer present the content acquired by the camera and cancel presenting the framing interface, regardless of whether the video is currently being acquired and whether the video acquisition mode is the user trigger mode or the automatic trigger mode. For example, regardless of whether the client device 110 is currently acquiring video, the client device 110 may no longer present the framing interface 220 in response to reception of the trigger on the cancel control 221. In some embodiments, in the case where the framing interface 220 is presented, the client device 110 may also no longer present the framing interface 220 in response to reception of the trigger on the visual acquisition control 211 again. Therefore, a plurality of controls may be provided on the framing interface, and the user may use the plurality of controls to select when to acquire visual data and how to acquire visual data, which may improve the convenience of user interaction.

In the embodiments of the present disclosure, during the question-answer interaction, the client device 110 may determine the target resolution for the visual data based on at least one of the type of the visual data required for the question-answer interaction, the interaction mode related to the visual data, or the device capability of the acquisition device. In some embodiments, the type of the visual data required for the question-answer interaction may include a video type and/or an image type. For different types of visual data, different resolutions may need to be considered.

In some embodiments, the interaction mode related to the visual data may include an automatic trigger interaction mode and a user trigger interaction mode. Interaction data required for different interaction modes may be different. As an example only, in the user trigger interaction mode, the interaction data required by the client device 110 typically includes the visual data and a query request (i.e., a question) for the visual data from the user. The visual data acquired by the client device 110 may serve as auxiliary data of the query request, and the visual data is used to assist in determining a reply for the query request. In the automatic trigger interaction mode, the interaction data required by the client device 110 may only include the visual data, and the client device 110 may determine the reply on its own based on the visual data without relying on the query request from the user.

In some embodiments, the interaction data of different interaction models includes the visual data, and different resolutions may be selected for the visual data for different interaction modes. For example, in the user trigger interaction mode, in consideration of user experience, it may be expected that the quality or efficiency of the reply needs to be guaranteed. In the automatic trigger interaction mode, considering that the user may not have a clear interaction intention, there may not be too strict requirements for the accuracy or efficiency of the reply result in the automatic trigger mode.

In some embodiments, the acquisition device for acquiring the visual data may be integrated in the client device 110 itself or may be attached to the client device 110 (and controlled by the client device 110). The client device 110 may be equipped with different acquisition devices, such as a front-facing camera, a rear-facing camera, a panoramic camera, etc. The device capabilities of these acquisition devices may be different, and the device capability here mainly refers to the acquisition capability of visual data, for example, the upper limit of resolution supported by different cameras may be different.

The model input provided to the machine learning model usually has certain dimensional requirements. For example, in the case where the model input includes the visual data, it is usually required that the resolution of the visual data is within a fixed range or that the resolution of the visual data is several fixed resolutions. In the case of providing the visual data of any resolution (if the visual data is an image data, the image data may be referred to as an original image) to the machine learning model, it is expected to determine a target resolution with a smallest resolution (aiming to save calculation amount) and a most appropriate aspect ratio while ensuring that the original image is not reduced (aiming to avoid information loss of the original image). In order to ensure the quality of the reply and the efficiency of the reply that are finally determined by the machine learning model, the client device 110 may determine the current specific interaction scenario based on the type of the visual data, the interaction mode related to the visual data, and/or the device capability of the acquisition device, and may determine the appropriate resolution to be applied based on the current interaction scenario.

In some embodiments, the correspondence between different application scenarios and resolutions may be preconfigured, and the client device 110 may select the target resolution of the visual data based on the correspondence. Referring to Table 1, Table 1 shows an example correspondence between various scenarios and resolutions:

TABLE 1

| | | Preview | Acquisition | Degradation | Upload | Degradation |
|---|---|---|---|---|---|---|
| | | interface | resolution | strategy | resolution | strategy |
| Rear- | Image | 1440*1080 | 1920*1440 | / | 1920*1440 | / |
| facing | acquisition | | | | | |
| | Video | 1440*1080 | 1920*1440 | 1440*1080 | 1920*1440 | 1440*1080 |
| | acquisition | | | | | |
| | Automatic | \|1440*1080 | 1920*1440 | 1440*1080 | 1920*1440 | 1440*1080 |
| | trigger | | | | | |
| Front- | Image | 1440*1080 | 1440*1080 | / | 1440*1080 | / |
| facing | acquisition | | | | | |
| | Video | 1440*1080 | 1440*1080 | / | 1440*1080 | / |
| | acquisition | | | | | |
| | Automatic | \|1440*1080 | 1440*1080 | / | 1440*1080 | / |
| | trigger | | | | | |

In the example of Table 1, the unit of resolution is pixel. Table 1 configures respective correspondences for the rear-facing camera and the front-facing camera. In Table 1, the “preview interface” refers to the resolution corresponding to the preview stream provided in the framing interface of the client device; the “acquisition resolution” refers to the resolution that may be provided when the corresponding acquisition device is applied to actually acquire video data; the “upload resolution” refers to the target resolution that may be selected by the client device under normal circumstances, and the “degradation strategy” refers to the target resolution that may be selected when the resolution degradation needs to be performed. The specific values of resolution in Table 1 are only given as examples, and other resolutions and the correspondence between scenarios and resolutions may also be configured depending on the specific device capability and application needs. In the following, how the client device determines the appropriate resolution in the current application scenario according to various factors will be described in detail.

After the target resolution is determined, the client device 110 will acquire the visual data according to the target resolution, and provide the acquired visual data to the machine learning model for processing. The machine learning model may determine the model output based at least on the visual data, and possibly also on the user's query request (if any) and interaction context information. The model output may be used to generate the reply for the visual data. The client device 110 may obtain the reply for the visual data for presentation to the user.

The machine learning model for processing the visual data may be any appropriate machine learning model, which may be based on any appropriate model structure. As an example only, the machine learning model may be a multimodal large language model (VLM). This machine learning model may be deployed locally on the client device 110 or on other electronic devices (e.g., the server device 120). If the machine learning model is deployed locally on the client device 110, the client device 110 may directly invoke the local machine learning model to process the visual data. If the machine learning model is deployed on the other electronic devices, the client device 110 may provide the acquired video frame to the other electronic devices via the communication connection with the other electronic devices. The other electronic devices may process the visual data by means of the machine learning model, and feed back the processing result to the client device 110.

How the client device determines the target resolution of the visual data is discussed in detail below. Referring to FIG. 3, FIG. 3 illustrates an example 300 of reply provision according to some embodiments of the present disclosure. During the interaction between the user and the digital assistant, the client device 110 may acquire the visual data and/or receive the voice from the user 140.

In some embodiments, the client device 110 may determine a plurality of acquisition scenarios of the visual data based on the interaction mode. The plurality of acquisition scenarios may include, for example, a user trigger scenario and an automatic trigger scenario 303. For the user trigger scenario, the client device 110 may further determine a plurality of sub-scenarios included in the scenario based on the type of the visual data. For example, the client device 110 may determine, based on the type of the visual data, that the user trigger scenario includes an image acquisition scenario 301 and a video acquisition scenario 302. The client device 110 may determine different visual data acquisition strategies for different acquisition scenarios. The client device 110 may determine an acquisition scenario matching the current situation based on at least one of the interaction mode and the type of the visual data, and then determine the target resolution for the visual data based on the acquisition strategy corresponding to the acquisition scenario.

In some embodiments, if the interaction mode related to the visual data indicates a user-triggered interaction (i.e., the visual data is acquired in response to reception of the trigger from the user 140 on a shooting control), the client device 110 may determine that the current visual data acquisition scenario is the image acquisition scenario 301 in response to the type of the visual data being an image type (i.e., the acquired visual data is the image). In some embodiments, if the interaction mode related to the visual data indicates the user-triggered interaction, the client device 110 may determine that the current visual data acquisition scenario is the video acquisition scenario 302 in response to the type of the visual data being a video type (i.e., the acquired visual data is the video). In some embodiments, if the interaction mode related to the visual data indicates an auto-triggered interaction, the client device 110 may determine that the current visual data acquisition scenario is the automatic trigger scenario 303.

In some embodiments, the client device 110 may first determine the upper limit of resolution supported by the device capability of the acquisition device. It may be understood that if the acquisition device includes a plurality of cameras, the client device 110 may determine the upper limit of resolution supported by the camera currently being applied. In some embodiments, if the upper limit of resolution supported by the device capability of the acquisition device currently applied is a first resolution, no matter which acquisition scenario the current visual data acquisition scenario is (i.e., no matter whether the current acquisition scenario is the image acquisition scenario 301, the video acquisition scenario 302, or the automatic trigger scenario 303), the client device 110 may determine that the target resolution for the visual data is the first resolution. The first resolution may be a predetermined, any appropriate resolution. That is, if the upper limit of resolution supported by the device capability of the acquisition device is relatively low, the client device 110 may determine the target resolution for the visual data to be fixed at the highest resolution that may be supported by the acquisition device directly without determining the type of the visual data required for the question-answer interaction and/or the interaction mode related to the visual data.

Generally, the resolution that may be supported by a front-facing camera of the client device 110 may be lower than the resolution that may be supported by a rear-facing camera of the client device 110. For example, the client device 110 may determine that the upper limit of resolution that may be supported by the front-facing camera is the first resolution, and may determine that the upper limit of resolution that may be supported by the rear-facing camera is higher than the first resolution. In the case where the client device 110 acquires the visual data via the front-facing camera, the client device 110 may determine that the resolution for the visual data is fixed at the highest resolution that may be supported by the front-facing camera. For example, in the correspondence of Table 1, in the scenario where the front-facing camera is used, the resolution that may be used by the client device 110 may all be a fixed resolution of 1440*1080 pixels, which is the upper limit of resolution of the front-facing camera.

In some embodiments, if the upper limit of resolution supported by the device capability of the acquisition device currently in use is higher than the first resolution (e.g., the acquisition device currently in use is not the front-facing camera, but other cameras supporting higher resolution, such as a rear-facing camera), the client device 110 may determine the target resolution based on at least one of the interaction mode and the type of the visual data. As an example, in the case where the client device 110 acquires visual data via the rear-facing camera, the client device 110 may determine the target resolution based on the current acquisition scenario.

Specifically, in the image acquisition scenario 301, the client device 110 may determine that the target resolution is a second resolution, and the second resolution is any appropriate resolution higher than the resolution of the preview stream of the acquisition device. The resolution of the preview stream is also the resolution of the visual data presented in the framing interface. The preview stream is also the visual data presented by the preview interface. In some embodiments, for the preview effect of the framing interface, the resolution of the preview stream of the framing interface in different application scenarios may all adopt the resolution that may be supported by the acquisition device, for example, the same resolution of 1440*1080 pixels as the front-facing camera.

As an example, continuing to refer to Table 1, in the case where the client device 110 acquires the image via the rear-facing camera, the client device 110 may determine that the resolution for the image is a second resolution higher than the resolution of the preview stream in response to the current acquisition scenario being the image acquisition scenario (i.e., determining to acquire data of the image type via the user trigger mode). The resolution of the preview stream may be, for example, 1440*1080 pixels, and the second resolution may be, for example, 1920*1440 pixels.

In the video acquisition scenario 302, the client device 110 may determine whether a resolution degradation strategy needs to be applied to the visual data. The client device 110 may determine, based on the resolution degradation strategy, that the target resolution for the visual data is a predetermined resolution in response to determining that the resolution degradation strategy needs to be applied. The predetermined resolution may be, for example, the resolution of the preview stream of the acquisition device. The client device 110 may also determine that the target resolution for the visual data is the second resolution higher than the resolution of the preview stream of the acquisition device in response to determining that the resolution degradation strategy does not need to be applied.

The client device 110 may determine whether the resolution degradation strategy needs to be applied based on any appropriate way. In some embodiments, the client device 110 may determine whether the resolution degradation strategy needs to be applied according to contextual information. The contextual information may include the device information of the client device 110, the device information of the acquisition device, the predetermined configuration information of the interaction, the historical data of the interaction, etc. For example, if the device information of the acquisition device indicates that the hardware performance of the acquisition device is poor, it may be determined that the acquisition device may not support the application of an excessively high resolution, and then it is determined that the resolution degradation strategy needs to be applied.

As an example, continuing to refer to Table 1, in the case where the client device 110 acquires an image via the rear-facing camera, if the current acquisition scenario is the video acquisition scenario (i.e., the client device 110 acquires data of the video type via the user trigger mode), the client device 110 may determine that the target resolution for the image is the second resolution (e.g., 1920*1440 pixels) in response to determining that the resolution degradation strategy does not need to be applied. If it is determined that the resolution degradation strategy needs to be applied, the client device 110 may determine that the target resolution for the image is the resolution of the preview stream (e.g., 1440*1080 pixels).

In the automatic trigger scenario 303, the client device 110 may also determine whether the resolution degradation strategy needs to be applied to the visual data. The client device 110 may determine, based on the resolution degradation strategy, that the target resolution for the visual data is a predetermined resolution in response to determining that the resolution degradation strategy needs to be applied. The predetermined resolution may also be, for example, the resolution of the preview stream of the acquisition device.

Similar to the video acquisition scenario 302, the client device 110 may also determine that the target resolution for the visual data is the second resolution higher than the resolution of the preview stream of the acquisition device in response to determining that the resolution degradation strategy does not need to be applied. The client device 110 may also determine whether the resolution degradation strategy needs to be applied based on any appropriate way, which is not limited in the present disclosure.

As an example, continuing to refer to Table 1, in the case where the client device 110 acquires the image via the rear-facing camera, if the current acquisition scenario is the automatic trigger scenario (i.e., the client device 110 acquires the visual data via the automatic trigger mode), the client device 110 may determine that the target resolution for the image is the second resolution (e.g., 1920*1440 pixels) in response to determining that the resolution degradation strategy does not need to be applied. If it is determined that the resolution degradation strategy needs to be applied, the client device 110 may determine that the target resolution for the image is the resolution of the preview stream (e.g., 1440*1080 pixels).

In summary, if the upper limit of resolution supported by the device capability of the acquisition device is higher than the first resolution, the client device 110 determines the target resolution based on at least one of the interaction mode and the type of the visual data. If the interaction mode indicates the user-triggered interaction and the type of the video data is the image type, the client device 110 may directly determine that the target resolution is the second resolution higher than the resolution of the preview stream of the acquisition device. If the interaction mode indicates the user-triggered interaction and the type of the video data is the video type, the client device 110 may further determine whether the resolution degradation strategy needs to be applied to the visual data.

If the interaction mode indicates the auto-triggered interaction, the client device 110 may further determine whether the resolution degradation strategy needs to be applied to the visual data, regardless of whether the type of the video data is the image type or the video type. The client device 110 may determine, based on the resolution degradation strategy, that the target resolution for the visual data is the predetermined resolution in response to determining that the resolution degradation strategy needs to be applied, and may determine that the target resolution for the visual data is the second resolution higher than the resolution of the preview stream of the acquisition device in response to determining that the resolution degradation strategy does not need to be applied.

In some embodiments, the client device 110 may extract the visual data from the preview stream of the acquisition device in response to determining that the target resolution is the predetermined resolution (i.e., the target resolution is the resolution of the preview stream). For example, referring to the example 300, the client device 110 may extract visual data from the preview stream 332 in the automatic trigger scenario 303. For example, the client device 110 may perform frame extraction on the preview stream (334). In some embodiments, in the case where the target resolution is the resolution of the preview stream, the client device 110 may extract only one video frame from the preview stream in response to determining that the visual data to be acquired is an image, and may extract a plurality of video frames from the preview stream to provide to the machine learning model for reply determination in response to determining that the visual data to be acquired is the video. The extraction of video frames may be performed at a predetermined interval (e.g., at a predetermined duration interval).

In some embodiments, the client device 110 may directly provide the acquired visual data to the machine learning model 360 regardless of the acquisition scenario (i.e., regardless of whether the visual data is the video or the image, whether the interaction mode is user-triggered or auto-triggered, and whether the upper limit of resolution supported by the device capability exceeds the first resolution). In some embodiments, regardless of the acquisition scenario, the client device 110 may also store the acquired visual data into an image storage platform 340. The resolution at which the client device 110 uploads the visual data to the image storage platform 340 is also the target resolution at which the client device 110 acquires the visual data.

The image storage platform 340 may be any appropriate image storage platform. The image storage platform 340 is deployed at the server device 120. The client device 110 may obtain an access link corresponding to the stored visual data from the image storage platform 340, and provide the obtained access link to the machine learning model 360. For example, the machine learning model 360 may access the image storage platform 340 in response to obtaining the access link, and obtain a plurality of pieces of visual data previously stored by the client device 110 from the image storage platform 340.

In some embodiments, when the machine learning model 360 is deployed at the server device 120, the client device 110 may provide the visual data or the access link corresponding to the visual data to the machine learning model 360 via the communication link 350. In some embodiments, in the case where the interaction mode is user-triggered, the client device 110 may also acquire the user's voice 310. The client device 110 may perform voice recognition on the voice 310 by means of a trained automatic speech recognition (ASR) model to determine the text 320 corresponding to the voice 310. In the case where the interaction mode is user-triggered, the client device 110 may also provide the text 320 to the machine learning model 360 via the communication link 350.

The client device 110 may obtain the model output of the machine learning model 360, and determine the reply for the visual data based on the model output. In some embodiments, the model output may be directly determined as the reply for the visual data. In some embodiments, some processing may also be performed on the model output, and the processed model output may be determined as the reply for the visual data. For example, the model output may be a reply text in text form, and text-to-speech (TTS) may be performed on the reply text to determine the reply voice corresponding to the reply text, and the reply voice may be determined as the reply corresponding to the visual data. It may be understood that the text-to-speech here is only an example of processing, and in practice any appropriate way may be used to determine the reply based on the model output.

To sum up, according to the embodiments of the present disclosure, the appropriate resolution strategy for the visual data may be determined based on one or more of the type of the visual data required for the question-answer interaction, the interaction mode related to the visual data, or the device capability of the acquisition device. This may flexibly determine the resolution of the visual data provided to the machine learning model based on the actual scenario, improve the effect of visual recognition of the model, and thus contribute to improving the quality of the reply and the efficiency of the reply.

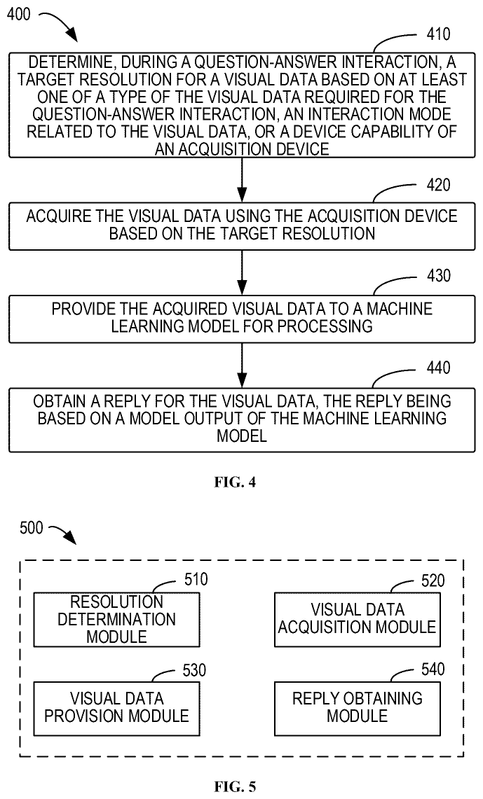

FIG. 4 illustrates a flowchart of a method 400 for reply provision according to some embodiments of the present disclosure. The method 400 may be implemented at the client device 110 of FIG. 1. The method 400 will be described with reference to the environment 100 of FIG. 1.

At block 410, the client device 110 determines, during a question-answer interaction, a target resolution for a visual data based on at least one of a type of the visual data required for the question-answer interaction, an interaction mode related to the visual data, or a device capability of an acquisition device.

At block 420, the client device 110 acquires the visual data using the acquisition device based on the target resolution.

At block 430, the client device 110 provides the acquired visual data to a machine learning model for processing.

At block 440, the client device 110 obtains a reply for the visual data, the reply being based on a model output of the machine learning model.

In some embodiments, determining the target resolution for the visual data includes: determining that the target resolution for the visual data is a first resolution in response to an upper limit of resolution supported by the device capability of the acquisition device being the first resolution.

In some embodiments, determining the target resolution for the visual data includes: determining the target resolution based on at least one of the interaction mode and the type of the visual data in response to the upper limit of resolution supported by the device capability of the acquisition device being higher than the first resolution.

In some embodiments, determining the target resolution based on at least one of the interaction mode and the type of the visual data includes: determining that the target resolution for the visual data is a second resolution in response to determining that the interaction mode indicates a user-triggered interaction and the type of the visual data is an image data, the second resolution being higher than a resolution of a preview stream of the acquisition device.

In some embodiments, acquiring the visual data using the acquisition device includes: acquiring the image data using the acquisition device according to a zero-latency shooting scheme.

In some embodiments, acquiring the visual data using the acquisition device includes: acquiring a plurality of images using the acquisition device; and merging the plurality of images to obtain the visual data to be provided to the machine learning model.

In some embodiments, determining the target resolution based on at least one of the interaction mode and the type of the visual data includes: determining whether to apply a resolution degradation strategy to the visual data in response to determining that the interaction mode indicates an auto-triggered interaction or the type of the visual data is a video data; and determining, based on the resolution degradation strategy, that the target resolution for the visual data is a predetermined resolution in response to determining to apply the resolution degradation strategy.

In some embodiments, the predetermined resolution is a resolution of a preview stream of the acquisition device, and acquiring the visual data using the acquisition device includes: extracting the visual data from the preview stream of the acquisition device in response to the target resolution being the predetermined resolution.

In some embodiments, determining the target resolution based on at least one of the interaction mode and the type of the visual data further includes: determining that the target resolution for the visual data is a second resolution in response to determining not to apply the resolution degradation strategy, the second resolution being higher than the resolution of the preview stream of the acquisition device.

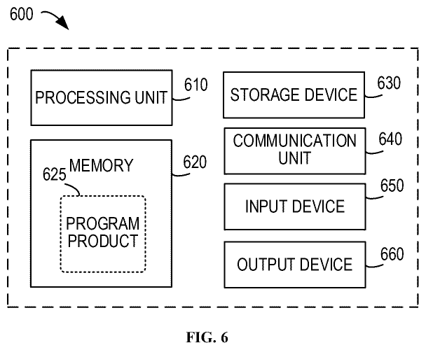

The embodiments of the present disclosure also provide a corresponding apparatus for implementing the above methods or processes. FIG. 5 illustrates an illustrative structural block diagram of an apparatus 500 for reply provision according to some embodiments of the present disclosure. The apparatus 500 may be implemented as or included in the client device 110. Various modules/components in the apparatus 500 may be implemented by hardware, software, firmware, or any combination thereof.

As shown in FIG. 5, the apparatus 500 includes a resolution determination module 510 configured to determine, during a question-answer interaction, a target resolution for a visual data based on at least one of a type of the visual data required for the question-answer interaction, an interaction mode related to the visual data, or a device capability of an acquisition device. The apparatus 500 also includes a visual data acquisition module 520 configured to acquire the visual data using the acquisition device based on the target resolution. The apparatus 500 also includes a visual data provision module 530 configured to provide the acquired visual data to a machine learning model for processing. The apparatus 500 also includes a reply obtaining module 540 configured to obtain a reply for the visual data, the reply being based on a model output of the machine learning model.

In some embodiments, the resolution determination module 510 is further configured to: determine that the target resolution for the visual data is a first resolution in response to an upper limit of resolution supported by the device capability of the acquisition device being the first resolution.

In some embodiments, the resolution determination module 510 is further configured to: determine the target resolution based on at least one of the interaction mode and the type of the visual data in response to the upper limit of resolution supported by the device capability of the acquisition device being higher than the first resolution.

In some embodiments, the resolution determination module 510 is further configured to: determine that the target resolution for the visual data is a second resolution in response to determining that the interaction mode indicates a user-triggered interaction and the type of the visual data is an image data, the second resolution being higher than a resolution of a preview stream of the acquisition device.

In some embodiments, the visual data acquisition module 520 is further configured to: acquire the image data using the acquisition device according to a zero-latency shooting scheme.

In some embodiments, the visual data acquisition module 520 is further configured to: acquire a plurality of images using the acquisition device; and merge the plurality of images to obtain the visual data to be provided to the machine learning model.

In some embodiments, the resolution determination module 510 is further configured to: determine whether to apply a resolution degradation strategy to the visual data in response to determining that the interaction mode indicates an auto-triggered interaction or the type of the visual data is a video data; and determine, based on the resolution degradation strategy, that the target resolution for the visual data is a predetermined resolution in response to determining to apply the resolution degradation strategy.

In some embodiments, the predetermined resolution is a resolution of a preview stream of the acquisition device, and the visual data acquisition module 520 is further configured to: extract the visual data from the preview stream of the acquisition device in response to the target resolution being the predetermined resolution.

In some embodiments, the resolution determination module 510 is further configured to: determine that the target resolution for the visual data is a second resolution in response to determining not to apply the resolution degradation strategy, the second resolution being higher than the resolution of the preview stream of the acquisition device.

The units and/or modules included in the apparatus 500 may be implemented in various ways, including software, hardware, firmware, or any combination thereof. In some embodiments, one or more units and/or modules may be implemented using software and/or firmware, such as machine-executable instructions stored on a storage medium. In addition to machine-executable instructions or as an alternative, some or all units and/or modules in the apparatus 500 may be implemented at least partially by one or more hardware logic components. As an example, rather than a limitation, example types of hardware logic components that may be used include a field programmable gate array (FPGA), application specific integrated circuit (ASIC), application specific standard (ASSP), system on chip (SOC), complex programmable logic device (CPLD), etc.

It should be understood that one or more steps of the above method may be performed by an appropriate electronic device or a combination of electronic devices. Such an electronic device or a combination of electronic devices may include, for example, the client device 110 and/or the server device 120 in FIG. 1.

FIG. 6 illustrates a block diagram of an electronic device 600 in which one or more embodiments of the present disclosure may be implemented. It should be understood that the electronic device 600 shown in FIG. 6 is only illustrative and should not constitute any limitation on the function and scope of the embodiments described herein. The electronic device 600 shown in FIG. 6 may be configured to implement the client device 110 and/or the server device 120 in FIG. 1.

As shown in FIG. 6, the electronic device 600 is in the form of a general electronic device. The components of the electronic device 600 may include, but are not limited to, one or more processors or a processing unit 610, a memory 620, a storage device 630, one or more communication units 640, one or more input devices 650, and one or more output devices 660. The processing unit 610 may be an actual or virtual processor and may execute various processes according to the programs stored in the memory 620. In a multi-processor system, multiple processing units execute computer executable instructions in parallel to improve the parallel processing capability of the electronic device 600.

The electronic device 600 typically includes multiple computer storage media. Such media may be any available medium that is accessible to the electronic device 600, including, but not limited to, a volatile and non-volatile medium, a removable and non-removable medium. The memory 620 may be a volatile memory (for example, a register, cache, a random access memory (RAM)), a non-volatile memory (such as a read-only memory (ROM), an electrically erasable programmable read-only memory (EEPROM), a flash memory), or any combination thereof. The storage device 630 may be any removable or non-removable medium, and may include a machine-readable medium such as a flash drive, a disk, or any other media, which may be used to store information and/or data and may be accessed within the electronic device 600.

The electronic device 600 may further include additional removable/non-removable, volatile/non-volatile memory media. Although not shown in FIG. 6, it is possible to provide a disk driver for reading from or writing to a removable, non-volatile disk (such as a “floppy disk”), and an optical disk driver for reading from or writing to a removable, non-volatile optical disk. In these cases, each driver may be connected to a bus (not shown) by one or more data medium interfaces. The memory 620 may include a computer program product 625, which has one or more program modules configured to perform various methods or actions of the various embodiments of the present disclosure.

The communication unit 640 enables communication with other electronic devices via the communication medium. Additionally, the functions of the components of the electronic device 600 may be implemented by a single computing cluster or multiple computing machines, which may communicate through communication connections. Therefore, the electronic device 600 may use a logical connection with one or more other servers, network personal computers (PCs) or another network node to operate in a networked environment.

The input device 650 may be one or more input devices, such as a mouse, a keyboard, a tracking ball, etc. The output device 660 may be one or more output devices, such as a display, a speaker, a printer, etc. The electronic device 600 may also communicate with one or more external devices (not shown) as needed via the communication unit 640, the external devices such as a storage device, a display device, etc., communicate with one or more devices that enable the user to interact with the electronic device 600, or communicate with any devices (e.g., a network card, a modem, etc.) that enable the electronic device 600 to communicate with one or more other electronic devices. Such communication may be performed via input/output (I/O) interfaces (not shown).

According to an example implementation of the present disclosure, a computer-readable storage medium is provided, on which computer-executable instructions are stored, where the computer-executable instructions are executed by a processor to implement the method described above. According to an example implementation of the present disclosure, a computer program product is further provided, the computer program product is tangibly stored on a non-transitory computer-readable medium and includes computer-executable instructions, and the computer-executable instructions are executed by a processor to implement the method described above.

Various aspects of the present disclosure are described herein with reference to the flowcharts and/or block diagrams of the method, apparatus, device and computer program product implemented according to the present disclosure. It should be understood that each block of the flowcharts and/or block diagrams, and the combination of each block in the flowcharts and/or block diagrams, may be implemented by computer-readable program instructions.

These computer-readable program instructions may be provided to the processing unit of a general-purpose computer, a special-purpose computer, or other programmable data processing apparatus to produce a machine, so that when these instructions are executed by the processing unit of the computer or other programmable data processing apparatus, an apparatus for implementing the functions/actions specified in one or more blocks in the flowcharts and/or block diagrams is produced. These computer-readable program instructions may also be stored in a computer-readable storage medium, these instructions cause the computer, the programmable data processing apparatus, and/or other devices to work in a specific way, so that the computer-readable medium storing these instructions includes a manufactured product, which includes instructions for implementing various aspects of the functions/actions specified in one or more blocks in the flowcharts and/or block diagrams.

The computer-readable program instructions may be loaded onto a computer, other programmable data processing apparatuses, or other devices, so that a series of operation steps are performed on the computer, the other programmable data processing apparatuses, or the other devices to produce a computer-implemented process, so that the instructions executed on the computer, the other programmable data processing apparatuses, or the other devices implement the functions/actions specified in one or more blocks in the flowcharts and/or block diagrams.

The flowcharts and block diagrams in the drawings show the possibly implemented architectures, functions, and operations of the system, the method, and the computer program product according to multiple implementations of the present disclosure. In this regard, each block in the flowcharts or block diagrams may represent a module, program segment, or part of an instruction, and the module, program segment, or part of an instruction contain one or more executable instructions for implementing the specified logical functions. In some implementations as updates, the functions marked in the blocks may also occur in an order different from that marked in the drawings. For example, two consecutive blocks may actually be performed substantially in parallel, or they may sometimes be performed in the reverse order, depending on the functions involved. It should also be noted that each block in the block diagrams and/or the flowcharts, and the combination of the blocks in the block diagrams and/or the flowcharts, may be implemented by a dedicated hardware-based system that performs the specified functions or actions, or may be implemented by a combination of dedicated hardware and computer instructions.

The implementations of the present disclosure have been described above, and the above description is illustrative, not exhaustive, and is not limited to the disclosed implementations. Without departing from the scope and spirit of the described implementations, many modifications and changes will be apparent to those of ordinary skill in the art. The terms used herein are chosen to best explain the principles, practical applications, or improvements to the technology in the market of the implementations, or to enable other those of ordinary skill in the art to understand various implementations disclosed herein.

1. A method for reply provision, comprising:
determining, during a question-answer interaction, a target resolution for a visual data based on at least one of a type of the visual data required for the question-answer interaction, an interaction mode related to the visual data, or a device capability of an acquisition device;
acquiring the visual data using the acquisition device based on the target resolution;
providing the acquired visual data to a machine learning model for processing; and
obtaining a reply for the visual data, the reply being based on a model output of the machine learning model.

2. The method of claim 1, wherein determining the target resolution for the visual data comprises:
determining that the target resolution for the visual data is a first resolution in response to an upper limit of resolution supported by the device capability of the acquisition device being the first resolution.

3. The method of claim 1, wherein determining the target resolution for the visual data comprises:
determining the target resolution based on at least one of the interaction mode and the type of the visual data in response to an upper limit of resolution supported by the device capability of the acquisition device being higher than a first resolution.

4. The method of claim 3, wherein determining the target resolution based on at least one of the interaction mode and the type of the visual data comprises:
determining that the target resolution for the visual data is a second resolution in response to determining that the interaction mode indicates a user-triggered interaction and the type of the visual data is an image data, the second resolution being higher than a resolution of a preview stream of the acquisition device.

5. The method of claim 4, wherein acquiring the visual data using the acquisition device comprises:
acquiring the image data using the acquisition device according to a zero-latency shooting scheme.

6. The method of claim 4, wherein acquiring the visual data using the acquisition device comprises:
acquiring a plurality of images using the acquisition device; and
merging the plurality of images to obtain the visual data to be provided to the machine learning model.

7. The method of claim 3, wherein determining the target resolution based on at least one of the interaction mode and the type of the visual data comprises:
determining whether to apply a resolution degradation strategy to the visual data in response to determining that the interaction mode indicates an auto-triggered interaction or the type of the visual data is a video data; and
determining, based on the resolution degradation strategy, that the target resolution for the visual data is a predetermined resolution in response to determining to apply the resolution degradation strategy.

8. The method of claim 7, wherein the predetermined resolution is a resolution of a preview stream of the acquisition device, and wherein acquiring the visual data using the acquisition device comprises:
extracting the visual data from the preview stream of the acquisition device in response to the target resolution being the predetermined resolution.

9. The method of claim 7, wherein determining the target resolution based on at least one of the interaction mode and the type of the visual data further comprises:
determining that the target resolution for the visual data is a second resolution in response to determining not to apply the resolution degradation strategy, the second resolution being higher than the resolution of a preview stream of the acquisition device.

10. An electronic device, comprising:
at least one processor; and
at least one memory, the at least one memory being coupled to the at least one processor and storing instructions executable by the at least one processor, the instructions, when executed by the at least one processor, causing the electronic device to perform acts comprising:
determining, during a question-answer interaction, a target resolution for a visual data based on at least one of a type of the visual data required for the question-answer interaction, an interaction mode related to the visual data, or a device capability of an acquisition device;
acquiring the visual data using the acquisition device based on the target resolution;
providing the acquired visual data to a machine learning model for processing; and
obtaining a reply for the visual data, the reply being based on a model output of the machine learning model.

11. The electronic device of claim 10, wherein determining the target resolution for the visual data comprises:
determining that the target resolution for the visual data is a first resolution in response to an upper limit of resolution supported by the device capability of the acquisition device being the first resolution.

12. The electronic device of claim 10, wherein determining the target resolution for the visual data comprises:
determining the target resolution based on at least one of the interaction mode and the type of the visual data in response to an upper limit of resolution supported by the device capability of the acquisition device being higher than a first resolution.

13. The electronic device of claim 12, wherein determining the target resolution based on at least one of the interaction mode and the type of the visual data comprises:
determining that the target resolution for the visual data is a second resolution in response to determining that the interaction mode indicates a user-triggered interaction and the type of the visual data is an image data, the second resolution being higher than a resolution of a preview stream of the acquisition device.

14. The electronic device of claim 13, wherein acquiring the visual data using the acquisition device comprises:
acquiring the image data using the acquisition device according to a zero-latency shooting scheme.

15. The electronic device of claim 13, wherein acquiring the visual data using the acquisition device comprises:
acquiring a plurality of images using the acquisition device; and
merging the plurality of images to obtain the visual data to be provided to the machine learning model.

16. The electronic device of claim 12, wherein determining the target resolution based on at least one of the interaction mode and the type of the visual data comprises:
determining whether to apply a resolution degradation strategy to the visual data in response to determining that the interaction mode indicates an auto-triggered interaction or the type of the visual data is a video data; and
determining, based on the resolution degradation strategy, that the target resolution for the visual data is a predetermined resolution in response to determining to apply the resolution degradation strategy.

17. The electronic device of claim 16, wherein the predetermined resolution is a resolution of a preview stream of the acquisition device, and wherein acquiring the visual data using the acquisition device comprises:
extracting the visual data from the preview stream of the acquisition device in response to the target resolution being the predetermined resolution.

18. The electronic device of claim 16, wherein determining the target resolution based on at least one of the interaction mode and the type of the visual data further comprises:
determining that the target resolution for the visual data is a second resolution in response to determining not to apply the resolution degradation strategy, the second resolution being higher than the resolution of a preview stream of the acquisition device.

19. A non-transitory computer-readable storage medium storing a computer program thereon executable by a processor to implement acts comprising:
determining, during a question-answer interaction, a target resolution for a visual data based on at least one of a type of the visual data required for the question-answer interaction, an interaction mode related to the visual data, or a device capability of an acquisition device;
acquiring the visual data using the acquisition device based on the target resolution;
providing the acquired visual data to a machine learning model for processing; and
obtaining a reply for the visual data, the reply being based on a model output of the machine learning model.

20. The non-transitory computer-readable storage medium of claim 19, wherein determining the target resolution for the visual data comprises:
determining that the target resolution for the visual data is a first resolution in response to an upper limit of resolution supported by the device capability of the acquisition device being the first resolution.
